(19) United States
(12) Patent Application Publication
(10) Pub. No.: US 2002/0050098 A1
(43) Pub. Date: May 2, 2002

(54) Rotary access locking apparatus

(76) Inventor: Kwon Kyong Chan, Pu Chun-Ci (KR)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 09/934,555

(22) Filed: Aug. 23, 2001

(30) Foreign Application Priority Data
Oct. 28, 2000 (KR) 20-0209608

(51) Int. Cl. E05D 15/02

(52) U.S. Cl. 49/42

(57) ABSTRACT

The present invention relates to a rotary access locking apparatus which is designed to perform rotation lock/position control/damping functions for a plurality of rotating plates arranged at constant intervals by a mechanical mechanism in the case that access is performed via the rotating plates. According to a preferred embodiment of the present invention, a rotary locking control apparatus which includes: a rotation unit provided with a cylindrical rotation housing having a plurality of rotating plates arranged at a constant angle in the vicinity thereof; and a rotation actuating/control unit for supporting the rotation of the rotation unit, allowing the rotating plate to be rotated only at a predetermined angle and damping the rotation, said rotation actuating/control unit having a rotation lock portion interlocked to the rotation of the rotating plate and releasing the lock state of the rotating plate only when normal access is permitted, a rotating position control portion for controlling the rotating plate to be kept at the predetermined angle at the rotation of the rotating plate, and a rotation damping portion for damping the rotation of the rotating plate.

### CROSS REFERENCE TO RELATED APPLICATION

This application claims priority from foreign patent application having application number 20-0209608, filed Oct. 28, 2000, which is hereby incorporated by reference.

### FIELD OF THE INVENTION

The present invention relates to a rotary access locking apparatus, and more particularly, to a rotary access locking apparatus which has a plurality of rotating plates arranged at a predetermined angle and is rotated at a constant angle only when a normal access is permitted, t for thereby enabling access.

### BACKGROUND OF THE INVENTION

For instance, at the gate of subway as a mass transit system, access locking apparatuses of various types are installed for permitting access of only passengers owning a ticket of a predetermined price. As such an access locking apparatus, a rotary type having a plurality of (i.e., three) legs is typical.

Such an access locking apparatus has a rotary hub ex tended at angle of approximately 45° in a vertical direction. The rotary hub is fixed to a stand having a control unit for performing settlement of tickets and is kept to be prevented from rotation at normal times. However, in the case that the insertion and settlement of a ticket are completed normally, the rotary hub is rotated ⅓ to permit access.

With respect to this, a rotary access control apparatus has been suggested which has a plurality of rotating plates rotated at a constant angle(e.g., 120°) opposite the direction of both sides of the stand defining an access passage and permits access by operating an electric motor and rotating the rotating plate under control of the control unit, for example, when the verification of a ticket is completed.

However, in case of the rotary access locking apparatus having a plurality of legs, each leg is extended to a Y direction and thus is positioned on the access passage, for thereby making a passer-by feel inconvenient.

In addition, in case of the rotary access locking apparatus for controlling access by controlling the rotation of the rotating plate installed opposite the stand at both sides, the electric motor for rotating the rotating plate is used and thus the manufacturing cost becomes higher.

### SUMMARY OF THE INVENTION

It is, therefore, an object of the present invention to provide a rotary locking control apparatus which includes: a rotation unit provided with a cylindrical rotation housing having a plurality of rotating plates arranged at a constant angle in the vicinity thereof; and a rotation actuating/control unit for supporting the rotation of the rotation unit, allowing the rotating plate to be rotated only at a predetermined angle and damping the rotation, said rotation actuating/control unit having a rotation lock portion interlocked to the rotation of the rotating plate and releasing the lock state of the rotating plate only when normal access is permitted, a rotating position control portion for controlling the rotating plate to be kept at the predetermined angle at the rotation of the rotating plate, and a rotation damping portion for damping the rotation of the rotating plate.

Preferably, the predetermined angle at which the rotating plate is arranged is 120°. The rotation lock portion includes a rotating body having a rotary connecting rod penetrating through the rotation housing engaged to the center, a plurality of stopper rollers rotatably installed by an engaging member at a lumbar space formed at the position conforming to the install direction of the rotating plate on the outer circumferential surface of the rotating body, a plurality of solenoids for transferring the applied force on the lock/unlock of the rotating plate, a first group of stopper arms for releasing the rotation lock state of the rotating plate by activation of the solenoids, and a connecting member interconnecting the front end of the solenoid and one end of the stopper arm and being installed to turn one point of the center by a rotary axis.

The predetermined position of the stopper arm is fixed so that it can be turned by the rotary axis, and the lower side of the front end thereof is controlled to have a curvature corresponding to that of the stopper roller. At normal times, the curvature-controlled lower side of the front end of the stopper arm locks the movement of the stopper roller.

In addition, the rotating position control unit includes: a plurality of rotation positioning parts contained in the lumbar portion formed in the intermediate outer circumference of the rotating body; an elastic spring contained in the lumbar groove formed at the center of the front end of the rotation positioning part and shifting the rotation positioning part forward/backward; a ring portion containing parts of the front end of the rotation positioning part; and a spring fixing member installed at a peripheral area of the containing lumbar portion of the rotation positioning part formed on the inner surface of the ring portion and preventing the detachment of the elastic spring.

Inside the cylindrical housing of the rotation actuating/control unit, a plurality of bearing members for supporting the rotation of the rotating body are installed in the vicinity of the lower extended portion of the rotating body.

In addition, the rotation damping portion includes: a wobble plate connected to the lower end of the lower extended portion of the rotating body; a buffering member providing rotation damping force of the rotating plate; and a guide frame member which is formed in a shape curved at a constant curvature, of which center is connected to be turned by the rotary axis, in which the front end of the gas cylinder member is contacted with the inner surface thereof and which has a rotary roller for supporting the rotation of the wobble plate installed at one end thereof.

Here, preferably, the wobble gate has a plurality of corners formed to be positioned in the middle of the angle at which the rotating plates are arranged.

In accordance with the rotary access locking apparatus of the present invention, in the condition that the rotating plate is kept in the lock state by the rotation lock portion, if the lock state caused by the rotation lock portion is released by the control unit, the rotating plate is made rotatable at a predetermined angle(120°). When the rotating plate is rotated at a constant angle(i.e., 60°), the rotating plate automatically rotates the residual rotating angle by the operation of the rotation positioning part and the elastic spring of the rotating position control unit. In this state, rapid rotation of the rotating plate is prevented by the wobble plate of the rotation damping portion and the buffering action of a buffering member, for thereby enabling a smooth access.

### BRIEF DESCRIPTION OF THE DRAWINGS

The above objects, features and advantages of the present invention will become more apparent from the following detailed description when taken in conjunction with the accompanying drawings, in which:

FIG. 1 is a phase diagram illustrating a state in which a rotary access locking apparatus is installed in accordance with a preferred embodiment of the present invention;

FIG. 2 is a view illustrating an outline construction of the rotary access locking apparatus in accordance with the preferred embodiment of the present invention;

FIG. 3 is a cross-sectional view illustrating the construction of a rotation actuating/control unit as shown in FIG. 2;

FIG. 4 is a cross-sectional view taken along line A-A of FIG. 3;

FIG. 5 is a cross-sectional view taken along line B-B of FIG. 3; and

FIG. 6 is a cross-sectional view taken along line C-C of FIG. 3.

### DETAILED DESCRIPTION OF THE PREFERRED EMBODIMENTS

A preferred embodiment of the present invention will now be described with reference to the accompanying drawings.

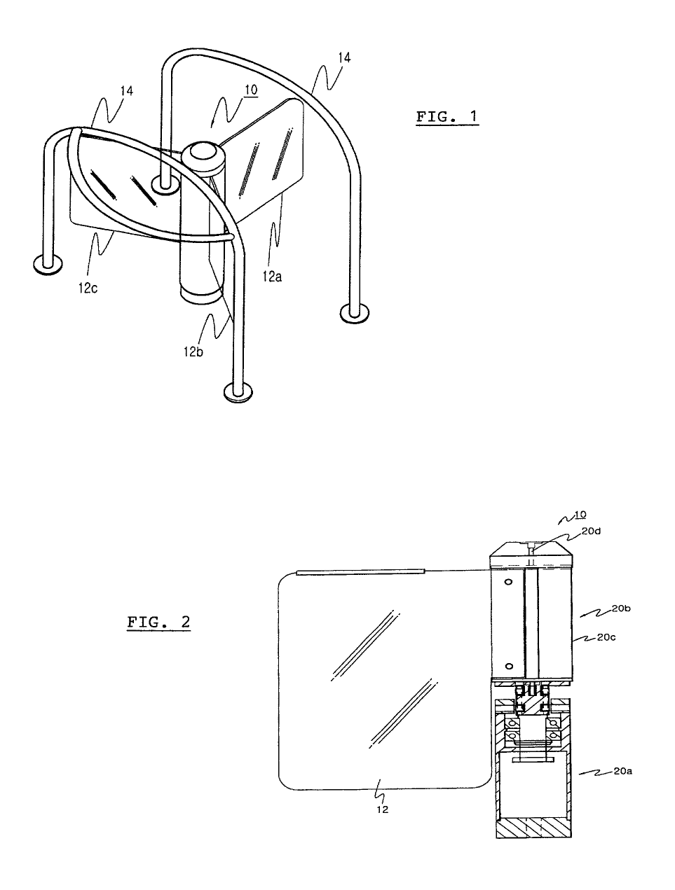

FIG. 1 is a phase diagram illustrating a state in which a rotary access locking apparatus is installed in accordance with a preferred embodiment of the present invention. In the drawing, reference numeral 10 denotes a rotary access locking apparatus in accordance with the present invention which can be installed, for example, at the gate of subway or at public facilities for permitting access of pedestrians. The rotary access locking apparatus 10 is provided with a plurality of rotating plates 12a through 12c installed at intervals of a predetermined angle (precisely, 120°) in the vicinity of the upper side thereof.

In addition, reference numeral 14 denotes a guide body for enabling passage via the rotary access locking apparatus 10.

FIG. 2 is a view illustrating an outline construction of the rotary access locking apparatus in accordance with the preferred embodiment of the present invention. The rotary locking control apparatus includes: a rotation actuating/control unit 20a for actuating/controlling the rotation of the rotating plates 12a through 12c and a rotation unit 20b which has the rotating plates 12a through 12c installed at a predetermined angle(i.e., 120°) in the vicinity and which is installed to rotate the rotation actuating/control unit 20b.

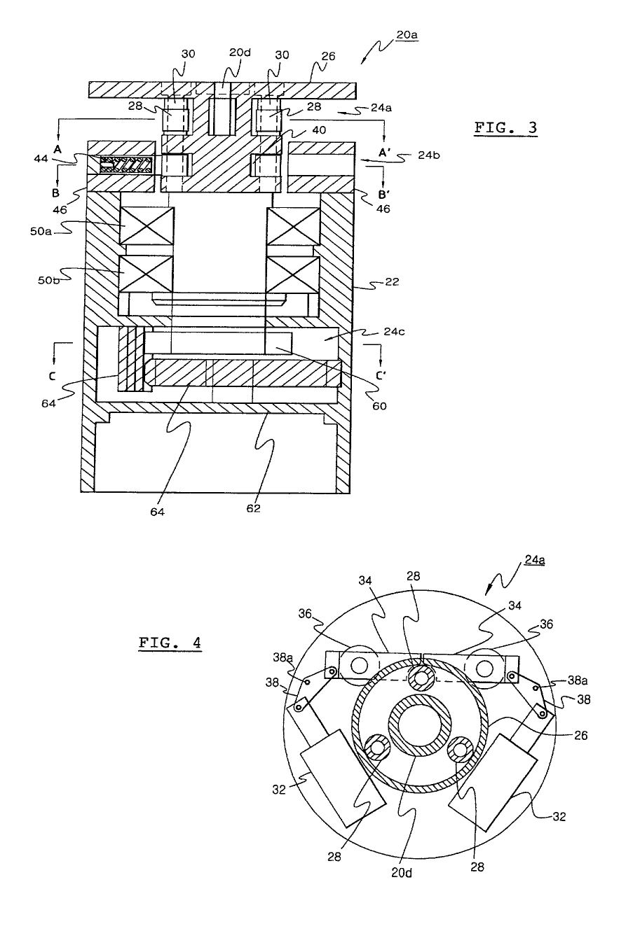

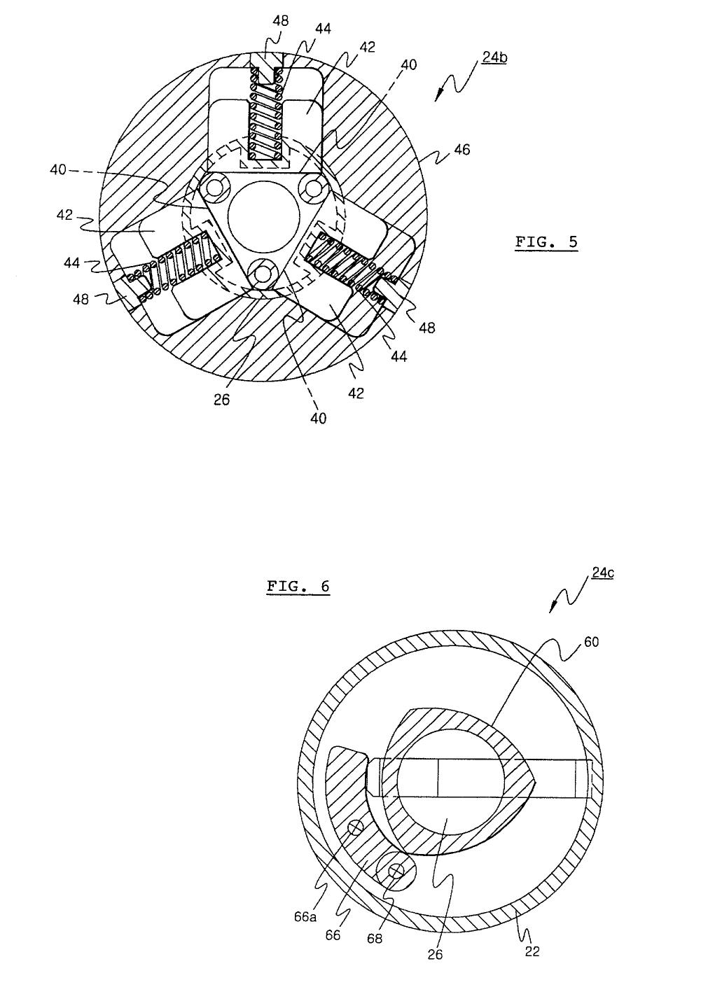

Moreover, FIG. 3 is a cross-sectional view illustrating the construction of a rotation actuating/control unit as shown in FIG. 2. FIG. 4 is a cross-sectional view taken along line A-A of FIG. 3. FIG. 5 is a cross-sectional view taken along line B-B of FIG. 3. FIG. 6 is a cross-sectional view taken along line C-C of FIG. 3.

Referring to the drawings, the rotation actuating/control unit 20a is provided with a cylindrical housing 22. At the upper side of the housing 22, a rotation lock portion 24a is provided for releasing the lock state of the rotating plates 12a through 12c only when access is permitted while keeping the rotation of the rotating plates 12a through 12c in the lock state at normal times.

Furthermore, at the lower side of the rotation lock portion 24a, a rotating position control portion 24b is provided inside the housing 22 in order to control the rotating plates 12a through 12c to be rotated accurately at a constant angle(120°) by the rotation lock portion 24a. At the lower side of the inside of the housing 22, a rotation damper portion 24c is provided for smoothly damping the rotation of the rotating plates 12a through 12c.

The rotation lock portion 24a is provided with a rotating body 26 having a rotary connecting rod 20d engaged to the center, said rotary connecting rod 20d penetrating through the cylindrical rotation housing 20c in which the rotating plates 12a through 12c are installed. At the lumbar space formed at the position conforming to the install direction of the rotating plates 12a through 12c on the outer circumferential surface of the rotating body 26, a plurality of stopper rollers 28 are installed to be rotatable by an engaging member 30 of a predetermined length.

Furthermore, according to the rotation lock portion 24a, a plurality of solenoids 32 of which activation is controlled by a control unit(not shown), for example, in the event that access is permitted by the verification of a ticket and a group of stopper arms 34 for releasing the rotation lock state of the rotating plates 12a through 12c are provided.

Here, a predetermined position of the stopper arm 34 is fixed to be rotatable by a rotary axis 36. The lower side of the front end thereof is controlled to have a curvature corresponding to that of the stopper roller 28 and the curvature-controlled lower side of the front end of the stopper arm 34 locks the movement of the stopper roller 28, for thereby preventing arbitrary rotation of the rotating plates 12a through 12c.

In addition, the front end of the solenoid 32 and one end of the stopper arm 34 are interconnected by a connecting member 38 installed so that one point of the center is turned by a rotary axis 38a.

Moreover, in the rotation lock portion 24a, in the case that normal access is to be permitted, when the solenoid 32 is activated by the control unit and thus the front end thereof is shifted backward, the connecting member 38 pulls one end of the stopper arm 34 as it is rotated on the rotary axis 38a. Accordingly, the stopper arm 34 releases the lock state of the stopper roller 28 as it is rotated on the rotary axis 36, for thereby enabling the rotation of the rotating plates 12a through 12c constructed in the rotation unit 20b.

In addition, according to the rotating position control unit 24b, a plurality of rotation positioning parts 42 are contained in the lumbar portion 40 formed in the intermediate outer circumference of the rotating body 26. The rotation positioning part 42 is installed to correspond to the rotating plates 12a through 12c, and the corresponding elastic spring 44 for shifting the rotation positioning part 42 forward and backward is mounted in the lumbar groove formed in the center of the front end at a constant depth.

Moreover, at the position corresponding to the lumbar portion 40 of the rotating body 26 at the upper side of the cylindrical housing 22, a ring portion 46 for containing parts of the front end of the rotation positioning part 42 on the inner surface is defined. In the outer walls of the lumbar portion containing the rotation positioning part 42 formed in the inner surface of the ring portion 26, a spring fixing member 48 for preventing detachment of the elastic spring 44 is provided.

Moreover, the rear end of the rotation positioning part 42 is extended over the engaging member 30 corresponding to the rotating plates 12a through 12c. Accordingly, in the case that the rotation of the rotating plates 12a through 12c is made, the rear end of the rotation positioning part 42 is pushed out forwardly by the engaging member 30. In the event that the rotating angle of the rotating plates 12a through 12c is more than approximately 60°, the rotation positioning part 42 is restored to the original position by the restoring force of the elastic spring 44 for thereby controlling the rotating plates 12a through 12c to be rotated accurately at a constant angle(i.e., 120°).

In addition, inside the housing 22, a plurality of bearing members 50a and 50b for supporting the rotation of the rotating body 36 are installed in the vicinity of the lower extended portion of the rotating body 36.

Moreover, the rotation damper portion 24c provided at the lower end of the lower extended portion of the rotating body 36 includes: a wobble plate 60 connected to the lower end of the lower extended portion of the rotating body 36 and having three corners formed to be installed in the middle of the angle at which the rotating plates 12a through 12c are arranged; a buffering member 64 of a gaseous shock absorber type axially connected onto a supporting frame 62 formed at a predetermined position of the bottom surface of the inside of the housing 22; and a guide frame member which is formed in a shape curved at a constant curvature, of which center is connected to be turned by the rotary axis 66a, in which the front end of the gas cylinder member is contacted with the inner surface thereof and which has a rotary roller 68 for supporting the rotation of the wobble plate 60 installed at one end thereof.

Here, in the rotation damper portion 24c, in the event that the rotating plates 12a through 12c are rotated, the wobble plate 60 is also rotated by the rotation of the rotating body 26. One corner of the wobble plate 60 is contacted with the rotary roller 68 at the position at which the rotating plates 12c through 12c are rotated 1/2 for thereby pressurizing the rotary roller 68 backward more or less. In this case, though the other end of the guide frame member 66 is pressurized inwardly. However, when it is buffered by the buffering member 64 and then the rotating plates 12a through 12c are rotated at more than a constant angle(i.e., 60°), the guide frame member 66 is prevented from rapid rotation again by the buffering operation of the buffering member 64, which is a damping operation.

In other words, according to the rotary access locking apparatus of the present invention, for example, in the case that normal access is to be permitted by the verification of a ticket, when the solenoid 32 of the rotation lock portion 24a is activated by a control unit(not shown) and thus the front end thereof is shifted backward, the connecting member 38 pulls one end of the stopper arm 34 as it is rotated on the rotary axis 38a. Accordingly, the stopper arm 34 releases the lock state of the stopper roller 28 as it is rotated on the rotary axis 36. In this condition, a passer-by can access by pushing out the rotating plates 12a through 12c constructed in the rotation unit 20b.

As described above, in the case that the rotation of the rotating plates 12a through 12c is made, the rear end of the rotation positioning part 42 constructed in the rotation control unit 24b is pushed out forwardly by the engaging member 30. In the event that the rotating angle of the rotating plates 12a through 12c is more than approximately 60°, the rotation positioning part 42 is restored to the original position by the restoring force of the elastic spring 44 for thereby controlling the rotating plates 12a through 12c to be rotated accurately at a constant angle(i.e., 120°).

Besides, when the driving plats 12a through 12c becomes a rotatable state and thus the passer-by pushes out the rotating plates 12a through 12c, the rotating body is also rotated. The damping function of the rotation damper portion 24c connected to the lower end of the rotating body 26 is performed by the rotation of the rotating body 26. That is, in the case that the rotating plates 12a through 12c are rotated, the wobble plate 60 is also rotated by the rotation of the rotating body 26. One corner of the wobble plate 60 is contacted with the rotary roller 68 at the position at which the rotating plates 12c through 12c are rotated ½ for thereby pressurizing the rotary roller 68 backward more or less. In this case, though the other end of the guide frame member 66 is pressurized inwardly. However, when it is absorbed by the buffering member 64 and then the rotating plates 12a through 12c are rotated at more than a constant angle(i.e., 60°), the guide frame member 66 is prevented from rapid rotation again by the buffering operation of the buffering member 64.

As described above, when the rotating plates 12a through 12c are rotated at a constant angle(i.e., 120°), they are kept in the lock state again by the stopper arm 34. Thus, the rotating plates 12a through 12c are kept in the lock state by the rotary control unit 24a until normal access is permitted later.

While the invention has been shown and described with reference to certain preferred embodiments thereof, it will be understood by those skilled in the art that various changes in form and details may be made therein without departing from the spirit and scope of the invention as defined by the appended claims. For example, the present invention can be adapted to rotary doors installed at the porches of large-sized buildings including large shopping malls to which a large number of unspecific persons frequently access.

As seen from above, in accordance with the rotary access locking apparatus of the present invention, a plurality of rotating plates arranged at a constant angle are designed to have a mechanism of having the functions of rotation control/rotation positioning/rotation damping. Accordingly, the rotating angle of the rotating plate is kept constant only when normal access is permitted and thus rapid rotation of the rotating plate is prevented, for thereby ensuring convenient passage and stability at the entrance and exit of a passer-by.

1. A rotary locking control apparatus, comprising:
a rotation unit provided with a cylindrical rotation housing having a plurality of rotating plates arranged at a constant angle in the vicinity thereof; and
a rotation actuating/control unit for supporting the rotation of the rotation unit, allowing the rotating plate to be rotated only at a predetermined angle and damping the rotation,
wherein said rotation actuating/control unit having a rotation lock portion interlocked to the rotation of the rotating plate and releasing the lock state of the rotating plate only when normal access is permitted, a rotating position control portion for controlling the rotating plate to be kept at the predetermined angle at the rotation of the rotating plate, and a rotation damping portion for damping the rotation of the rotating plate.

2. The apparatus of claim 1, wherein the predetermined angle at which the rotating plate is arranged is 120°, and the rotation lock portion comprises a rotating body having a rotary connecting rod penetrating through the rotation housing engaged to the center, a plurality of stopper rollers rotatably installed by an engaging member at a lumbar space formed at the position conforming to the install direction of the rotating plate on the outer circumferential surface of the rotating body, a plurality of solenoids for transferring the applied force on the lock/unlock of the rotating plate, a first group of stopper arms for releasing the rotation lock state of the rotating plate by activation of the solenoids, and a connecting member interconnecting the front end of the solenoid and one end of the stopper arm and being installed to turn one point of the center by a rotary axis.

3. The apparatus of claim 2, wherein the predetermined position of the stopper arm is fixed so that it can be turned by the rotary axis, and the lower side of the front end thereof is controlled to have a curvature corresponding to that of the stopper roller. At normal times, the curvature-controlled lower side of the front end of the stopper arm locks the movement of the stopper roller.

4. The apparatus of claim 1, wherein the rotating position control unit comprising:
a plurality of rotation positioning parts contained in the lumbar portion formed in the intermediate outer circumference of the rotating body;
an elastic spring contained in the lumbar groove formed at the center of the front end of the rotation positioning part and shifting the rotation positioning part forward/backward;
a ring portion containing parts of the front end of the rotation positioning part; and
a spring fixing member installed at a peripheral area of the containing lumbar portion of the rotation positioning part formed on the inner surface of the ring portion and preventing the detachment of the elastic spring.

5. The apparatus of claim 1, wherein inside the cylindrical housing of the rotation actuating/control unit, a plurality of bearing members for supporting the rotation of the rotating body are installed in the vicinity of the lower extended portion of the rotating body.

6. The apparatus of claim 1, wherein the rotation damping portion comprising: a wobble plate connected to the lower end of the lower extended portion of the rotating body; a buffering member providing rotation damping force of the rotating plate; and a guide frame member formed in a shape curved at a constant curvature, of which center is connected to be turned by the rotary axis, where the front end of the gas cylinder member is contacted with the inner surface thereof and which has a rotary roller for supporting the rotation of the wobble plate installed at one end thereof.

7. The apparatus of claim 6, wherein the wobble gate has a plurality of corners formed to be positioned in the middle of the angle at which the rotating plates are arranged.
